(19) United States
(12) Patent Application Publication
(10) Pub. No.: US 2013/0343227 A1
(43) Pub. Date: Dec. 26, 2013

(54) Communication system including a non-overlapping ring network and method of establishing a smooth growth non-overlapping ring network

(71) Applicants: Thomas P. Chu, Englishtown, NJ (US); Ahmet Akyamac, Bridgewater, NJ (US)

(72) Inventors: Thomas P. Chu, Englishtown, NJ (US); Ahmet Akyamac, Bridgewater, NJ (US)

(21) Appl. No.: 13/833,590

(22) Filed: Mar. 15, 2013

Related U.S. Application Data
(63) Continuation-in-part of application No. 13/528,889, filed on Jun. 21, 2012.

(51) Int. Cl. H04L 12/70

(52) U.S. Cl. CPC H04L 49/45
USPC 370/255

(57) ABSTRACT

According to an illustrative embodiment, a communication system includes a plurality of nodes. The nodes are communicatively connected to form a plurality of non-overlapping rings. At least one of the rings has an order of a plurality of node positions that corresponds to a smooth growth non-overlapping ring network configuration.

### BACKGROUND

In some known network topologies, nodes may be arranged in a bus topology where a common backbone connects all of the nodes. In other known network topologies, nodes may be arranged in a ring topology where each node in a chain has two neighbors and the last node connects back to the first node. In still other known network topologies, nodes may be arranged in a star topology where each of the child nodes connect directly back to one parent node. In still other known network topologies, nodes may be arranged in a tree topology where a root node spawns one or more levels of nodes and each child node on a lower level connects directly to their parent at a higher level of the tree. In still other known network topologies, nodes may be arranged in a mesh topology where one or more of the nodes connect to one or more of the other nodes providing a plurality of paths through the network.

### SUMMARY

Disclosed embodiments provide a method and communication system including a smooth growth non-overlapping ring network that reduces costs (e.g., the number of network links and the complexity associated with establishing such links) while providing resiliency to failure and meeting quality of service requirements (e.g., network delay attributed to traversing the network architecture).

According to an illustrative embodiment, a communication system includes a plurality of nodes. The nodes are communicatively connected to form a plurality of non-overlapping rings. At least one of the rings has an order of a plurality of node positions that corresponds to a smooth growth non-overlapping ring network configuration.

According to an illustrative embodiment, a method of establishing a smooth growth non-overlapping ring network comprises selecting at least one initial network configuration comprising a plurality of nodes. The nodes are in an order corresponding to direct communicative connections between nodes that are immediately adjacent each other in the order. At least one criterion is selected and the smooth growth non-overlapping ring network has to satisfy that criterion. A respective plurality of additional nodes in respective node position orders are added to the initial network configuration. A maximum number of nodes in the respective pluralities of additional nodes that can satisfy the at least one criterion when they are added to the initial network configuration is determined. The smooth growth non-overlapping ring network is established based on the initial network configuration and the plurality of additional nodes that has a greatest determined maximum number of nodes.

### BRIEF DESCRIPTION OF THE DRAWINGS

Various embodiments are illustrated in the accompanying drawings, in which:

FIG. 1 schematically illustrates an embodiment of a data center system architecture including an exemplary data center 100A and a network 100B;

FIG. 2 schematically illustrates a block diagram of an exemplary node cluster 260 in a flexible data center network architecture;

FIG. 3 schematically illustrates an exemplary node cluster that includes non-overlapping rings;

FIG. 4 schematically illustrates a technique for establishing a smooth growth non-overlapping ring network.

FIG. 5 is a flowchart diagram summarizing an example approach for establishing a smooth growth non-overlapping ring network.

FIG. 6 is a flowchart diagram illustrating another feature of an example technique.

FIG. 7 schematically illustrates a smooth growth non-overlapping ring network configuration according to one example embodiment.

FIG. 8 schematically illustrates another example embodiment of a smooth growth non-overlapping ring network.

FIG. 9 schematically illustrates another example embodiment of a smooth growth non-overlapping ring network.

To facilitate understanding, identical reference numerals have been used among the drawings to designate elements having substantially the same or similar structure or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a method and apparatus of providing a non-overlapping ring-mesh network topology which reduces costs (e.g., the number of network links) while providing resiliency to failure and meeting QoS requirements (e.g., network delay attributed to traversing the network architecture). In particular, a set of target nodes belonging to a cluster are connected through N rings. Each node is member of all N rings and no link between nodes in a ring is duplicated in another ring. Advantageously, the non-overlapping ring-mesh topology requires a decreased number of connectors at each node and total network connections in order to provide the resiliency to failure, high connectivity and comparable hop count of the shortest path between two nodes of other known network topologies such as mesh and cluster topologies.

Though description and drawings illustrate embodiments of the non-overlapping ring-mesh topology in a switch cluster in a data center, it will be appreciated that the non-overlapping ring-mesh topology may be used to provide connectivity between nodes in any suitable network.

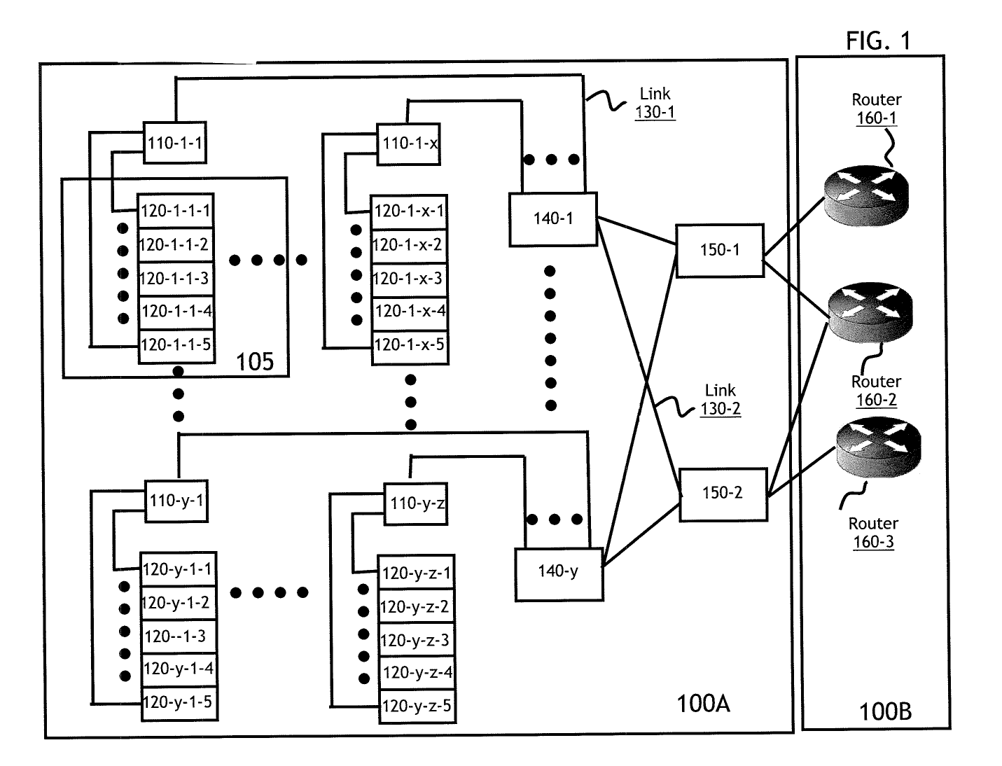

FIG. 1 illustrates an embodiment of a data center system architecture including an example data center 100A and a network 100B. The data center 100A includes the resources 120-1-1-1-120-y-z-5 (collectively, resources 120). Resources 120 are arranged in “y” rows, where each row contains a number (e.g., illustratively “x” or “y”) of racks of resources (e.g., rack 105) that are accessed through a communication path. The communication path communicatively connects resources 120 with network 100B via an appropriate one of the top of the rack switches 110-1-1-110-y-z (collectively, TOR switches 110), an appropriate one of the end of the row switches 140-1-140-n (collectively, EOR switches 140), an appropriate one of the layer 2 aggregation switches 150-1-150-n (collectively, aggregation switches 150) and appropriate links 130-1-130-2 (collectively, links 130). Remaining link labels have been omitted for the purpose of clarity. Communication between data center 100A and network 100B is via one of aggregation switches 150, an appropriate one of routers 160-1-160-3 (collectively, routers 160), and appropriate links 130. It should be appreciated that a data center may be arranged in any suitable configuration and that the illustrated data center 100A is just one example architecture being used for discussion purposes. For example, the communication path may include any suitable configuration of devices (e.g., switches, routers, hubs, etc.) to switch data between the resources 120 and network 1006.

TOR switches 110 switch data between resources in an associated rack and an appropriate EOR switch. For example, TOR switch 110-1-1 switches data from resources in rack 105 to network 1006 via an appropriate EOR switch (e.g., EOR switch 140-1).

Resources 120 may be any suitable devices or nodes, such as processors (e.g., compute nodes that are configured to perform at least one computing operation), memory, storage, switches, routers or network elements. It should be appreciated that while five resources are illustrated in each rack (e.g., rack 105), each rack may include fewer or more resources and each rack may contain different types or numbers of resources. In some embodiments, an application may be supported by multiple component instances such as virtual machines (VMs) or virtualized storage. These component instances may include varied resources connected within the data center network architecture 100A.

As illustrated, each resource 120 is labeled using a row-column-resource number nomenclature. For example, resource 120-2-3-4 would be the fourth resource in the rack residing in the second row and third column.

EOR switches 140 switch data between an associated TOR switch and an appropriate aggregation switch. For example, EOR switch 140-1 switches data from TOR switches 110-1-1-210-1-x to network 100B via an appropriate aggregation switch (e.g., aggregation switch 150-1 or 150-2).

Aggregation switches 150 switch data between an associated EOR switch and an appropriate router. For example, TOR switch 110-1-1 switches data from resources in rack 105 to network 100B via an appropriate EOR switch (e.g., EOR switch 140-1) and an appropriate aggregation switch (e.g., aggregation switch 150-1 or 150-2).

Routers 160 switch data between network 1006 and data center 100A via an appropriate aggregation switch. For example, router 160-1 may switch data from network 1006 to data center 100A via aggregation switch 150-1.

The network 1006 includes any number of access and edge nodes and network devices and any number and configuration of links (not shown for purposes of clarity). Moreover, it should be appreciated that network 100B may include any combination and any number of wireless, or wire line networks including: LTE, GSM, CDMA, Local Area Network(s) (LAN),

Wireless Local Area Network(s) (WLAN), Wide Area Network (WAN), Metropolitan Area Network (MAN), or the like.

In some embodiments, TOR switches 120 or EOR switches 140 are Ethernet switches.

In some embodiments, TOR switches 120 or EOR switches 140 may be arranged to be redundant. For example, rack 105 may be serviced by two or more TOR switches 110.

In some embodiments, aggregation switches 150 are layer 2 Ethernet switches.

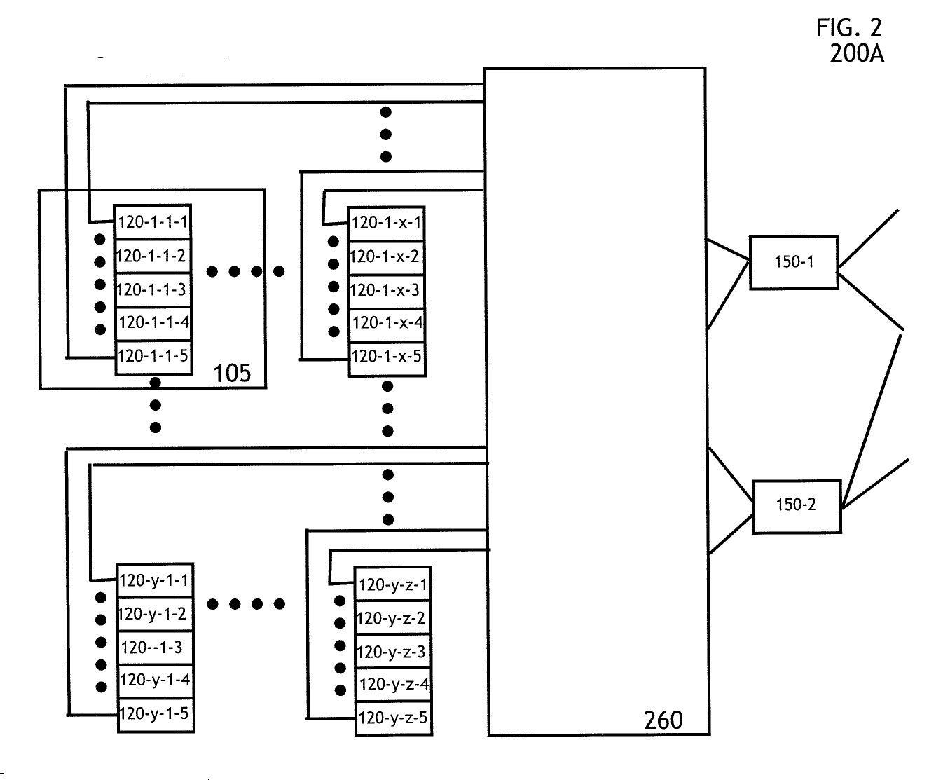

FIG. 2 illustrates a block diagram of an exemplary switch cluster 260 in a flexible data center network architecture 200A. The flexible data center network architecture 200A includes the resources 120 and aggregation switches 150 as described above in FIG. 1. Switch cluster 260 includes a number of target nodes that switch data between resources 120 and aggregation switches 150 as described herein.

It should be appreciated that switch cluster 260 may be arranged in any suitable configuration and that switch cluster 260 is just one example architecture being used for discussion purposes. In some embodiments, switch cluster 260 may include the TOR switches 110 from FIG. 1 (and not the EOR switches 140 as illustrated in FIG. 2). In some embodiments, switch cluster 260 may include the EOR switches 140 from FIG. 1.

In some embodiments, the flexible data center network architecture 200A may contain more switch cluster 260s. In some of these embodiments, TOR switches or EOR switches may be arranged in a plurality of switch clusters. In some of these embodiments, one or more of the plurality of switch clusters may be designed to support a particular quality of service (QoS) criteria. For example, virtual machines or virtualized storage may be placed in appropriate clusters upon creation depending on their QoS requirements or the location of their peers.

In some embodiments, the switch clusters may be deployed in addition to a conventional network topology such as a tree network topology. Advantageously, a switch cluster arrangement may off-load traffic from the north-south links of the tree network.

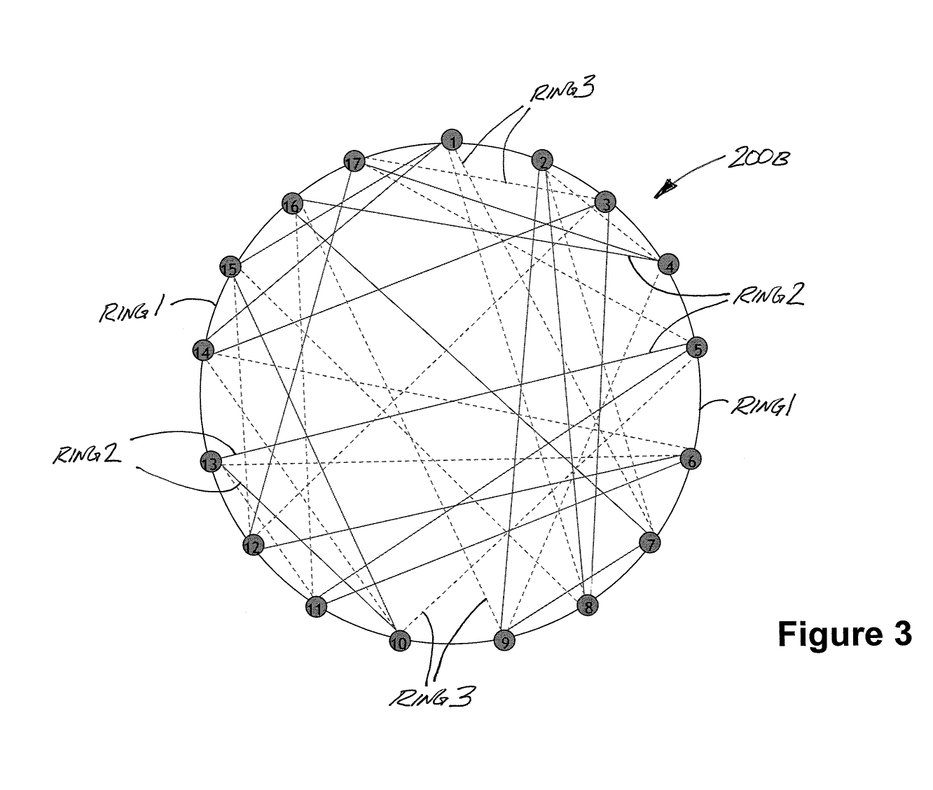

FIG. 3 illustrates a functional block diagram of an example data center system 200B including a plurality of nodes 1-17. In some examples the nodes comprise computing devices, such as resources 120, that are configured to perform at least one computing operation. In some examples, the nodes comprises switches, such as the switch cluster 260 of FIG. 2 (e.g., a portion or all of the TOR switches 120, a portion or all of the EOR switches 140, or some combination of TOR and EOR switches. The nodes 1-17 are interconnected in ring networks. In particular, the nodes 1-17 are connected through N “non-overlapping rings”, with each node being a member of all N of the rings. In the illustrated example, N=3.

A ring that is one of a plurality of “non-overlapping rings” does not have any link between nodes that is duplicated in another ring. In the illustrated example, all three of the non-overlapping rings have the same nodes. Each of the illustrated nodes has a direct link with each of two other nodes in each ring. The two nodes with which a first one of the nodes is directly linked in one of the rings are different than the two nodes directly linked with that first one of the nodes in each of the other rings.

Seventeen nodes are illustrated for discussion purposes but data center 200B may include fewer or more nodes. It should be appreciated that nodes may include connections to components other than target nodes making up the switch cluster. For example, nodes may connect to: (i) resources (e.g., resources 120 of FIG. 2), (ii) aggregation switches (e.g., aggregation switches 150 of FIG. 2), (iii) other switching nodes (e.g., if the TOR switches 110 of FIG. 1 are clustered in a plurality of switch clusters), or (iv) the like.

Links support communicating over one or more communication channels such as: wireless communications (e.g., LTE, GSM, CDMA, Bluetooth); femtocell communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, links may be any number or combinations of communication channels.

As illustrated, data center 200B is a three-hop network including 17 nodes arranged in three “non-overlapping rings”. A first one of the rings, Ring1, is illustrated using curved lines to represent respective communicative connections or links between adjacent ones of the nodes 1-17. A second one of the rings, Ring2, is illustrated using solid straight lines to represent the links between nodes. A third one of the rings, Ring3, is illustrated using broken straight lines to represent the links between the nodes. As can be appreciated from the illustration all of the rings include the same nodes 1-17 and none of the direct links between respective nodes in one of the rings are in either of the other rings.

The non-overlapping rings illustrated in FIG. 3 can be represented using the following notation, in which the numbers 1-17 represent the nodes 1-17, respectively:

Ring 1={1, 2, 3, 4, 5, 6, 7, 8, 9, 10, 11, 12, 13, 14, 15, 16, 17}

Ring 2={1, 14, 3, 8, 2, 9, 7, 16, 4, 17, 12, 6, 11, 5, 13, 10, 15}

Ring 3={1, 7, 2, 4, 9, 16, 11, 13, 6, 14, 10, 5, 17, 3, 12, 15, 8}

The notation {n1, n2, n3, n4, . . . , nk} denotes a ring where neighboring nodes (e.g., those that are immediately adjacent to each other in the presented order) are connected without another of the nodes between them (e.g., directly linked to each other) and the node nk is connected back to the n1.

Connecting the nodes in a non-overlapping ring arrangement provides route diversity, resiliency and high connectivity. For example, the non-overlapping rings allow for using fewer connectors at a node and fewer network links than a conventional super cluster arrangement while still providing protection against a single failure (e.g., node or link) and providing comparable throughput (e.g., a comparable hop count).

An “N-hop” network of this description provides N-hop connectivity (or less) between substantially any combination of nodes in the node cluster where “substantially” means greater than ninety nine percent (99%). In other words, constructions of an N-hop node cluster may include possible node cluster constructions where communication between two selected nodes requires more than N hops. For example, considering 1000 potential a 3-hop, 64 node network configurations constructed using 4 non-overlapping rings may have a percentage of node combinations requiring 4 hops of the total potential node combinations in the range from 0.00%-0.15%. In a second example, 1000 potential ring constructions for a 3-hop, 80 node network constructed using 4 non-overlapping rings may have a percentage of node combinations requiring 4 hops of the total potential node combinations in the range from 0.00%-0.47%.

In some embodiments, the nodes include a routing protocol such as IS-IS (ISO 10589) to determine the topology of the network and use the shortest path between two nodes in forwarding data (e.g., packets).

As can be appreciated by considering the links that are schematically shown in FIG. 3, the task of establishing connections among the nodes when multiple non-overlapping rings are used can be difficult. The relatively complex network of links shown in FIG. 3 may be achieved with some effort but if any changes are made to the network, such as additional nodes being added, it becomes extremely challenging to remove some of the links and establish new ones so that the non-overlapping ring criteria (e.g., not having any duplicate links among the different rings and maintaining a desired number of hops for communications on the ring) are still met. One feature of the invention embodied in the various examples explained within this description is a technique for arranging the nodes in a node position order that facilitates a more readily achievable and economically feasible link arrangement among the nodes in a plurality of non-overlapping rings. The disclosed technique also accommodates the ability to change the number of nodes within the network in a relatively straight forward manner that facilitates avoiding technician error and redesign efforts that otherwise would be associated with making such changes to the network.

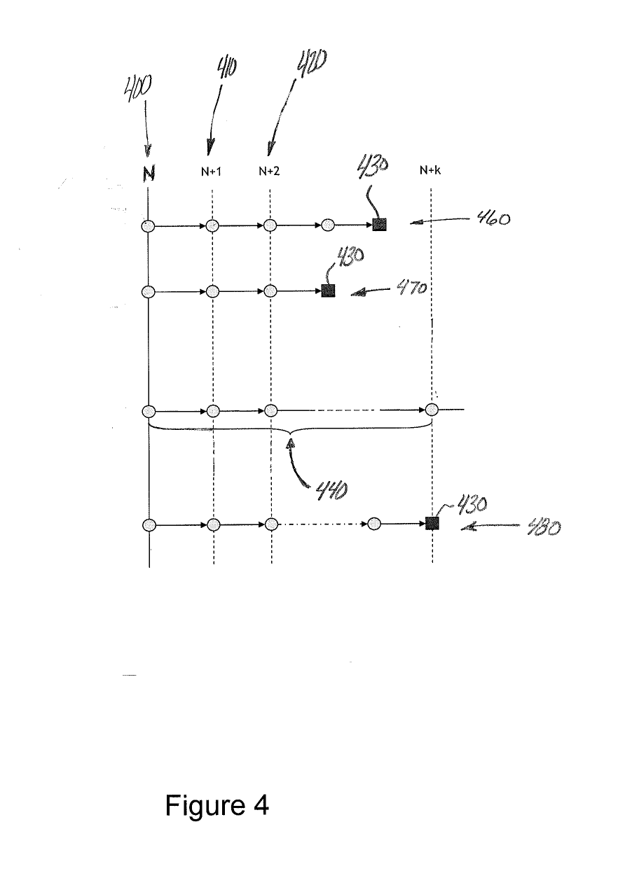

FIG. 4 schematically illustrates a technique for establishing a smooth growth non-overlapping ring network (SG-NOR network). An initial network configuration N is established having some baseline number of nodes. A ring construction algorithm allows for constructing a non-overlapping ring network with N nodes and R rings consistent with the description provided above. A ring growth algorithm allows for inserting a new or additional node to an existing non-overlapping ring network in a manner that results in a new or revised non-overlapping ring network. One example includes using a known Monte Carlo method for randomly selecting a new or additional node to be added to an existing NOR network while satisfying the criteria imposed on that NOR network.

According to one example, an SG-NOR network is constructed by assuming that the initial or baseline NOR network will satisfy a given criteria, referred to as criteria C. A NOR network is established with an appropriate number of rings and nodes using a ring construction algorithm like that described above. If that network satisfies the criteria C, a new or additional node is added to the network using the ring growth algorithm and the resulting network is tested to see whether it satisfies the criteria C. This is schematically shown in FIG. 4 where an initial network configuration N at 400 satisfies the criteria C and an additional node is added at 410 so that the network has N+1 nodes.

Additional or new nodes are repeatedly added until the resulting network no longer satisfies the criteria C. In FIG. 4 additional nodes are added at 420, for example, and the point at which a particular order of nodes in a candidate network no longer satisfies the criteria C is schematically illustrated at 430. The ring growth algorithm includes storing the configuration of the network that satisfies the criteria C with the size of the network for a particular growth sequence. In one example, for the same initial network configuration N, the ring growth algorithm includes executing a predetermined number of growth sequences and then selecting the growth sequence that has the largest number of nodes that satisfy the criteria C. In the case of FIG. 4, a SG-NOR network configuration schematically shown at 440 includes more nodes (i.e., N+k) than any other of the resulting network configurations shown at 460, 470 and 480. The network configuration schematically shown at 440 may then be selected as a SG-NOR network node position order for any NOR network requiring a number of nodes up to N+k nodes.

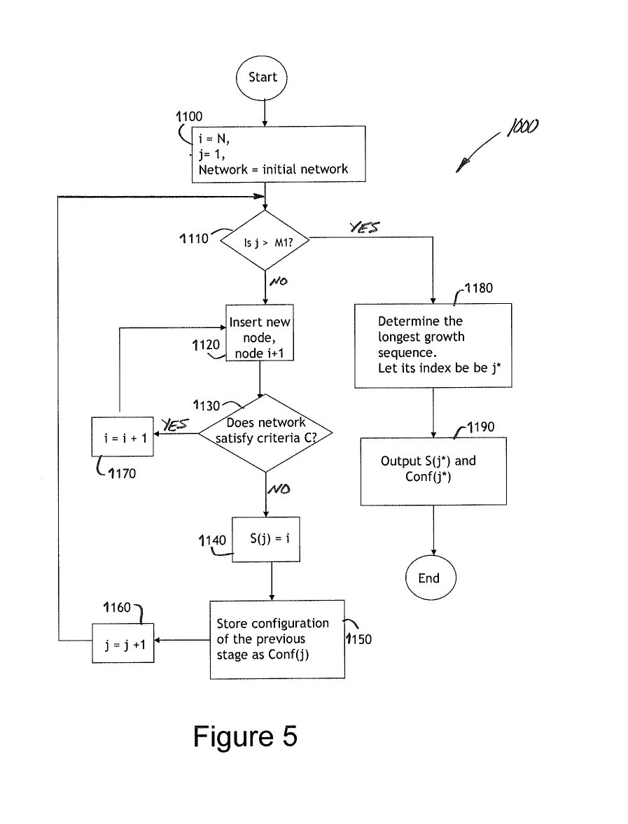

FIG. 5 is a flowchart diagram summarizing an example ring growth algorithm. The flowchart 1000 of FIG. 5 will be described using the following notation:

n is the number of nodes of the current network, which is initially set to N (i.e., the initial network configuration);

M1 is the total number of growth sequences that will be executed, which is set to one at the beginning of the flowchart 1000;

j is the parameter used as an index indicating the number of the current growth sequence;

S(j) is the size of the terminating network of the growth sequence j; and

Conf (j) is the network configuration of the last stage of the growth sequence j that satisfies the criteria C.

The process summarized in FIG. 5 begins at 1100 where the parameters i and j are initialized to N and 1, respectively. The network is set at the initial network or baseline network configuration. At 1100 a determination is made whether j is greater than M1. If j is greater than M1, this indicates that the algorithm has already executed the maximum number of growth sequences desired for a particular implementation. Provided that the maximum number of growth sequences has not yet been executed, a new node i+1 is inserted into the current NOR network at 1120.

At 1130, a determination is made whether the new NOR network satisfies the criteria C. If the new NOR network satisfies the criteria C, then the value of i is incremented at 1170 and another new or additional node is inserted at 1120.

Once a node is added such that the network no longer satisfies the criteria C, the size of the resulting network is established at 1140 and the configuration of the previous stage of the network (i.e., the network configuration prior to adding the node that resulted in no longer being able to satisfy the criteria C) is stored as Conf (j) at 1150. The previous configuration of the network can easily be obtained from the current network by removing the node i+1 that was most recently inserted into the network. At 1160, the growth sequence number j is incremented and the next growth sequence proceeds.

Eventually the desired number of growth sequences will have been completed and the determination made at 1110 indicates that j is greater than M1. At this point, the process summarized in FIG. 5 includes determining the longest growth sequence of all of the growth sequences to identify the SG-NOR network configuration that includes the greatest number of nodes N+k that satisfy the criteria C. At 1190, the size of the identified SG-NOR network and the network configuration, such as the order of the node positions indicating which nodes are to be communicatively connected directly to an adjacent node in the ring are stored. In the event that there is more than one SG-NOR network that has the same maximum number of nodes N+k, any of them may be randomly selected. Other selection criteria are also possible. One example includes determining a lowest average HOP count among any such network configurations for identifying the one which will be used as the SG-NOR network.

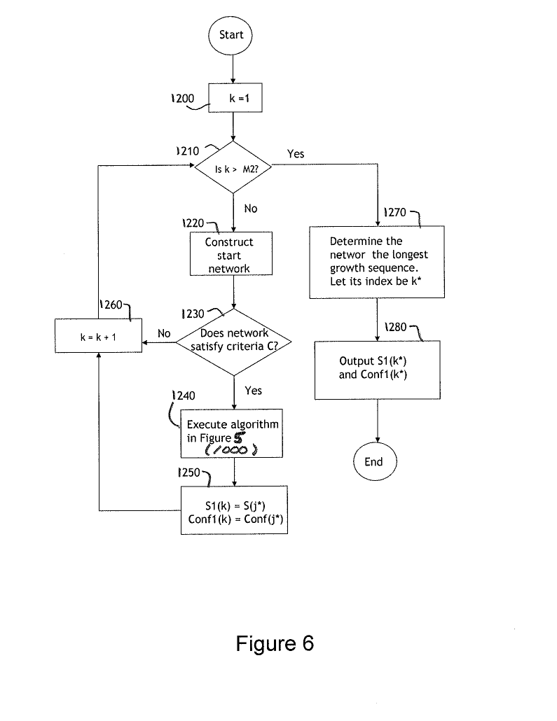

The example of FIGS. 4 and 5 is based upon using a single initial or baseline network configuration N. Some embodiments include repeating the process summarized in FIG. 5 using a plurality of initial network configurations. One approach of this type is summarized in the flowchart of FIG. 6 in which the following notation is used:

M2 is the number of start networks or initial network configurations that will be used;

k is the index of a current initial network configuration;

S1(k) is the maximum size of the terminating network for the initial network with the index k; and

Conf1(k) is the network configuration of the SG-NOR network having the maximum number of nodes beginning with the initial network k.

The example of FIG. 6 begins at 1200 where the index of the initial network is set to 1. At 1210 a determination is made whether k is greater than M2. This determination indicates whether all of the initial networks have been evaluated.

Assuming that all of the initial networks have not yet been considered, the process continues at 1220 where an initial network will be created based on a set of parameters, such as the number of nodes and the number of rings so that the initial NOR network N may be realized for this iteration. At 1230, a determination is made whether the initial network configuration satisfies the criteria C. Assuming that it does, the process shown in FIG. 5 (e.g., the flow chart 1000) is executed at 1240. This particular configuration k of the start network N is utilized for generating a plurality of networks configurations for determining the one that has the greatest number of nodes while still satisfying the criteria C.

At 1250, the two outputs S(j*) and Conf (j*) are used for establishing the values S1(k) and Conf1(k), respectively.

At 1260, the index k for the initial network configuration is incremented and the new value of k is evaluated at 1210. Once the desired number of initial networks have been utilized with the process summarized in FIG. 5, a determination is made at 1270 to identify the network including the largest growth sequence. An index of the selected initial network is set to k*. At 1280, the size S1(k*) and network configuration Conf1(k*) are provided as an output to indicate the SG-NOR that satisfies the criteria C and has the maximum number of nodes capable of satisfying that criteria.

For discussion purposes, consider a network diameter of 3 hops as one design criterion. Beginning with an initial network having 11 nodes and two non-overlapping rings, the algorithm summarized in FIG. 6 may be executed for 100 initial networks with 100 growth sequences (i.e., performing the process summarized in FIG. 5, 100 times) for each initial network. The resulting network with the longest growth sequence in one example includes 25 nodes. According to this example used for discussion purposes, a SG-NOR network is established that is useful for NOR networks that include between 11 and 25 nodes with a diameter of 3 hops for all stages of the SG-NOR network. One example corresponds to the 25 node, two ring NOR network described above.

Consider another example in which the initial network is designed to have 22 nodes and three rings. Assuming the process summarized in FIG. 6 is executed for 100 initial network configurations and the process of FIG. 5 is executed 100 times for each of those initial network configurations, a SG-NOR network may be established that includes a maximum of 49 nodes. Such a SG-NOR network may be used for a NOR network that includes between 22 nodes (i.e., the size of the initial network design configuration) and 49 nodes (i.e., the maximum number of nodes that satisfies the criteria C) so that the diameter of the network is 3 hops for all stages of the SG-NOR network.

According to one example, the configuration of the 3-ring 49-node SG-NOR network rings at its last stage is as follows:

R1: {1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49}

R2: {1 20 8 42 26 49 24 33 13 41 29 3 7 16 48 32 2 43 37 35 9 45 47 18 38 46 6 30 44 34 27 12 40 14 4 19 31 36 11 5 23 28 21 10 39 22 17 25 15}

R3: {1 5 33 44 19 34 23 16 9 47 30 24 21 27 8 29 40 42 31 12 48 20 18 26 2 7 25 45 13 32 35 4 39 15 41 649 11 46 22 43 38 28 37 3 17 10 36 14}

According to another embodiment, a 2-ring 25 node SG-NOR network is as follows at its last stage:

R1: {1 2 3 4 5 22 23 24 25}

R2: {1 8 22 17 25 6 23 14 16 3 24 9 18 11 5 2 20 5 7 12 4 19 21 13 10}

For situations in which a larger NOR network is desired, it is possible to use the techniques described above to establish a SG-NOR network with each ring including up to 86 nodes with four rings in the network so that the diameter of the network is 3 hops for all stages of the SG-NOR network.

One of the features of a SG-NOR network is that a user can determine a network configuration with an initial network being the first stage of the SG-NOR network. The user has a clear indication of how such a network would grow if additional nodes are eventually added. Further, the user may more readily determine when additional rings may be needed. Another feature of an SG-NOR network designed according to an embodiment of this invention is that is provides the foundation for a cabling architecture for NOR networks that is far less prone to technician error, is far easier to troubleshoot and is more economical to implement and service compared to a NOR network that does not include an SG-NOR configuration.

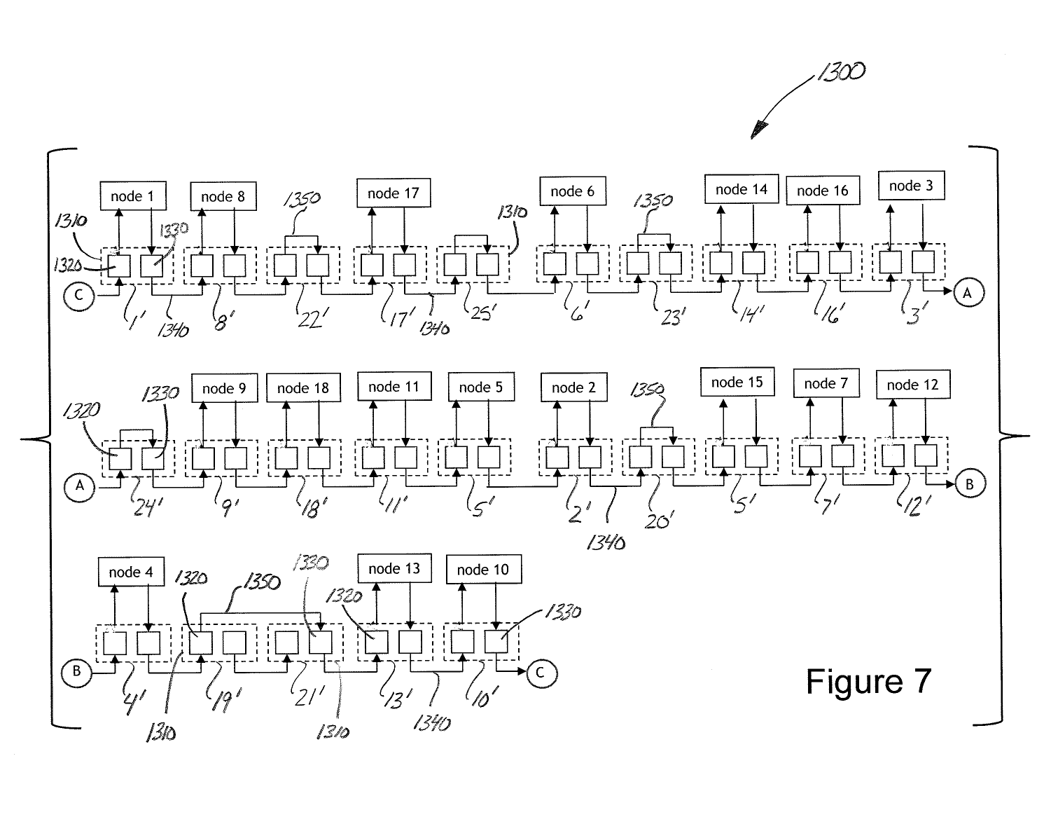

FIG. 7 schematically illustrates selected portions of an example SG-NOR network configuration, which corresponds to one of the rings in the 2-ring SG-NOR network mentioned above. An example ring 1300 comprising a SG-NOR network includes 18 nodes. For discussion purposes, the nodes may be considered to be network or computing devices such as switches, processors or servers that are part of a modular data center. The nodes 1-18 may be any type of compute node or computing device that is configured for performing at least one computing operation, for example.

An array of connectors 1310 are situated relative to the nodes for establishing links between the nodes such that they are communicatively connected to each other. One example embodiment includes an optical patch panel comprising a plurality of optical cross-connectors for facilitating cabling the SG-NOR network. Optical cabling is used as one example type of conductor for establishing the connections among the nodes along with the connectors 1310. In the example of FIG. 7, each connector 1310 includes an input adapter or port 1320 and an output adapter or port 1330. When a node is associated with a connector 1310, the ports 1320 and 1330 are used for establishing connections between that node and the immediately adjacent nodes in the order of nodes within the SG-NOR network. Conductors 1340 connect the output port 1330 of one connector (and an appropriately associated node) with the input port 1310 of an immediately adjacent connector. One feature of using an optical patch panel is that the number of connectors 1310 are usually situated in an array including a plurality of rows and each connector 1310 has a socket at a front end and a back end. Optical cable may be used as a conductor for making connections between ports 1320 and 1330 with little signal loss.

The SG-NOR configuration of the ring 1300 includes an order of node positions as follows: {1, 8, 22, 17, 25, 6, 23, 14, 16, 3, 24, 9, 18, 11, 5, 2, 20, 15, 7, 12, 4, 19, 21, 13, 10}. When all of the node positions includes a node, that may be referred to as the full configuration of the SG-NOR. Assuming that the ring 1300 is one of two rings for an SG-NOR network with a 3 hop maximum criteria, the other ring may be realized by using a node position order from node 1-node 25 in numerical order.

The configuration in FIG. 7 is capable of accommodating up to 25 nodes. In the illustration, only 18 nodes have been included in the network at the illustrated stage. Some of those nodes may be removed or additional nodes may be added. Using the SG-NOR configuration facilitates making those changes in a relatively straight forward and reliable manner.

In the example of FIG. 7, two adapters or ports 1320 or 1330 are assigned to each connector 1310 and each connector 1310 is assigned to a node position n′. For example, as shown in FIG. 7, the node 1 is associated with a connector 1310 at the node position 1′ and the node 17 is associated with the connector 1310 at the node position 17′.

There are more node positions or connectors 1310 available in FIG. 7 than there are nodes presently in the illustrated ring 1300. The connectors 1310 at the node positions 19′ to 25′ do not have an associated node. Instead, a jumper cable 1350 is placed across the corresponding input ports 1320 and output ports 1330 to avoid communication losses between nodes that have intervening connectors 1310 without an associated node. The example of FIG. 7 is a uni-directional ring in the sense that the receiver adapter of each node is directly coupled to only one other node and the transmitter adapter of each node is directly coupled to the receiver adapter of a next node in the node order of the SG-NOR network.

The arrangement in FIG. 7 facilitates altering the network by adding nodes when needed in a relatively straightforward manner. For example, if a 19^{th} node is to be added, the connector at the node position 19′ is identified. The jumper cable 1350 in FIG. 7 that is between in the input port 1320 of the connector 1310 at the node position 19′ and the output port 1330 of the connector 1310 at the node position 21′ is removed from the input port 1320 of the connector 1310 at the node position 19′. That same end of the jumper cable 1350 may be inserted into the input port 1320 of the connector 1310 at the node position 21′ or a new jumper cable may be inserted connecting the input and the output ports of the connector 1310 at the node position 21′. The node 19 may then be connected with the adapters or ports 1320 and 1330 of the connector 1310 at the node position 19′. One feature of the illustrated example is that a technician only needs to access one side of the patch panel for inserting a new node. The conductors 1340 on the back side are fixed and do not require any alteration.

Those skilled in the art will appreciate that the arrangement schematically shown in FIG. 7 greatly simplifies the task of realizing a SG-NOR network. It satisfies at least one criterion and provides non-overlapping rings by utilizing the node order of the SG-NOR network determined in a manner as described above.

If a third ring were required, another SG-NOR network configuration having a different order of node positions could be implemented on another portion of the same optical patch panel or a separate optical patch panel.

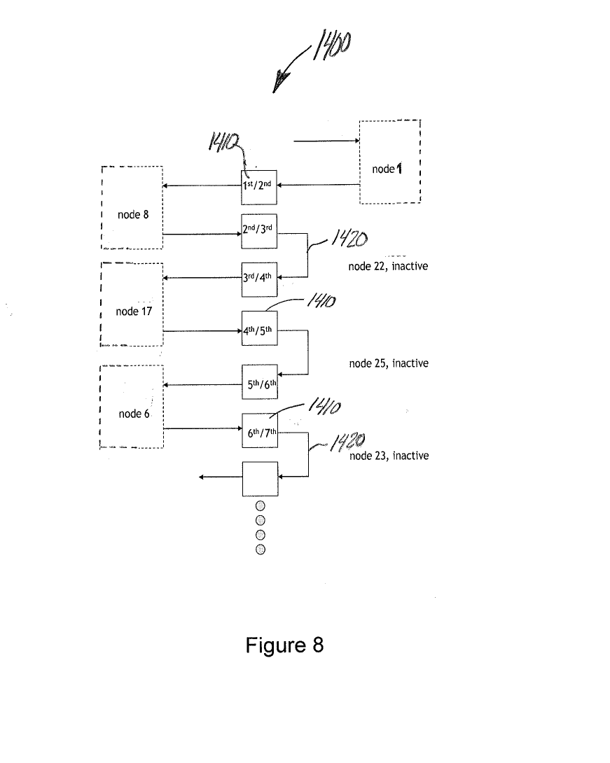

FIG. 8 schematically illustrates another ring configuration 1400 that includes a patch panel that is accessible from both sides. A plurality of ports 1410 on the patch panel can be used for establishing known types of connections between nodes and the adapter ports of the connectors 1410. As can be appreciated from FIG. 8, jumper cables or other conductors 1420 may be included between the adapters or connectors 1410 where a node has not yet been deployed within the ring. The manner in which additional nodes may be included in the ring 1400 is similar to that described above in connection with the embodiment of FIG. 7.

As jumper cables may degrade transmission quality, consecutive jumper cables may be replaced by a single long jumper cable. Those skilled in the art who have the benefit of this description will be able to determine an appropriate jumper cable configuration to meet their particular needs.

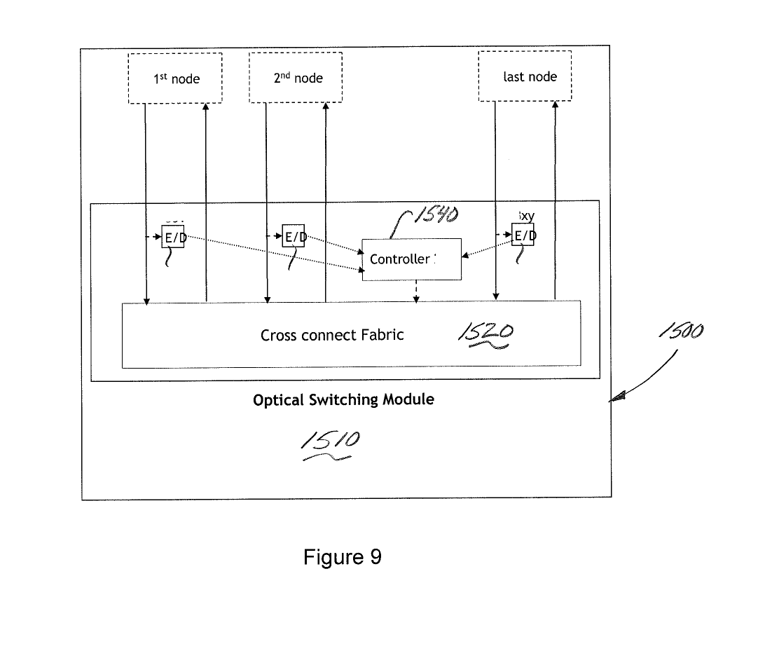

FIG. 9 schematically illustrates another embodiment of a ring configuration 1500. In this example, an optical switching module 1510 includes a cross-connect fabric 1520 in which may be realized using a micro mirror array, for example. The cross-connect fabric 1520 is configured to be associated with the individual nodes in a manner that a controller 1530 knows the node position order. Establishing the connections between the different nodes in this example is accomplished by appropriately informing or programming the controller 1540 with the relative node positions in the node order of the SG-NOR network. This allows the controller 1530 to control the cross-connect fabric 1520 to establish the desired links between the nodes in the appropriate node order. Changing the network by adding nodes, for example, includes informing or otherwise programming the controller 1530 of the new node. The controller 1530 in some examples was previously provided with information regarding all node locations of the SG-NOR network configuration. The controller 1530 makes any adjustments to or in the cross-connect fabric 1520 to accommodate the new node and the appropriate connections with adjacent nodes.

One feature of the example of FIG. 9 is that energy detection modules 1550 are associated with each node and the cross-connect fabric 1520 to detect when a node is not functioning properly or disabled administratively. In the case of a node that is determined to be malfunctioning or disabled administratively, the controller 1540 may effectively bypass such a node by controlling the cross-connect fabric 1520 to avoid any communication breaks along the ring network.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

We claim:

1. A communication system, comprising:
a plurality of nodes that are communicatively connected to form a plurality of non-overlapping rings;
at least one of the rings having an order of a plurality of node positions that corresponds to a smooth growth non-overlapping ring network configuration.

2. The system of claim 1, wherein
the smooth growth non-overlapping ring network configuration comprises a threshold number of node positions; and
the order of node positions satisfies at least one criterion regarding communication among the nodes.

3. The system of claim 2, wherein
a first order of node positions includes a first number of nodes that satisfies the at least one criterion;
a second order of node positions includes a second number of nodes that satisfies the at least one criterion; and
the threshold number of node positions corresponds to a greater of (i) the first number of nodes and (ii) the second number of nodes.

4. The system of claim 3, wherein
the first number of nodes is a maximum number of nodes in the first order that can satisfy the at least one criterion; and
the second number of nodes is a maximum number of nodes in the second order that can satisfy the at least one criterion.

5. The system of claim 1, wherein a number of the node positions is greater than a number of the nodes.

6. The system of claim 5, wherein
a first one of the node positions is assigned to a first node of the plurality;
a second one of the node positions is assigned to a second node of the plurality;
a third one of the node positions does not have an assigned node of the plurality; and
a position of the third one of the node positions is between the first and second node positions in the order of node positions.

7. The system of claim 1, wherein
a first one of the rings has a first order of node positions that corresponds to a first smooth growth non-overlapping ring network configuration; and
a second one of the rings has a second, different order of node positions that corresponds to a second smooth growth non-overlapping ring network configuration.

8. The system of claim 1, wherein the order of node positions defines direct communicative connections between the node positions that are immediately adjacent each other in the order.

9. The system of claim 1, comprising a plurality of connectors assigned to the node positions, respectively, the connectors having respective input and output ports, and wherein
the nodes are communicatively connected with the respective connectors assigned to a node position corresponding to the node;
the connectors are situated relative to each other in a manner corresponding to the order of node positions;
at least one of the ports of a first one of the connectors assigned to a first one of the node positions is immediately adjacent at least one of the ports of a second one of the connectors assigned to a second one of the node positions; and
the first one of the node positions is immediately adjacent the second one of the node positions in the order of node positions.

10. The system of claim 9, wherein there are more node positions than nodes, the system comprising a plurality of conductors communicatively connected with at least selected ones of the ports, and wherein
some of the connectors are situated between an input port of one of the nodes and an output port of another one of the nodes that is directly communicatively coupled with the one node; and
some (or none) connectors maybe situated between an input port and an output port of one of the connectors at a node position that does not have a corresponding node.

11. A method of establishing a smooth growth non-overlapping ring network comprising the steps of:
selecting at least one initial network configuration comprising a plurality of nodes that are in a node position order corresponding to direct communicative connections between nodes that are immediately adjacent each other in the order;
determining at least one criterion that is to be satisfied by the smooth growth non-overlapping ring network;
adding a respective plurality of additional nodes in respective node position orders to the initial network configuration;
determining a maximum number of nodes in the respective pluralities of additional nodes that can satisfy the at least one criterion when added to the initial network configuration; and
establishing the smooth growth non-overlapping ring network based on the initial network and the plurality of additional nodes that has a greatest determined maximum number of nodes.

12. The method of claim 11, comprising
selecting a plurality of initial network configurations;
adding a respective plurality of additional nodes in respective node position orders to the initial network configurations, respectively;
determining the maximum number of nodes in the respective pluralities of additional nodes that can satisfy the at least one criterion when added to the initial network configurations; and
establishing the smooth growth non-overlapping ring network based on the one of the initial network configurations with the plurality of additional nodes that has the greatest determined maximum number of nodes.

13. The method of claim 11, wherein
the smooth growth non-overlapping ring network comprises a plurality of computing nodes configured to perform at least one computing operation; and
a number of the node positions provided by the smooth growth non-overlapping ring network is greater than a number of the computing nodes.

14. The method of claim 13, comprising
assigning a first one of the node positions of the established smooth growth non-overlapping ring network a first one of the computing nodes;
assigning a second one of the node positions of the established smooth growth non-overlapping ring network to a second one of the computing nodes;
and wherein
a third one of the node positions of the established smooth growth non-overlapping ring network does not have an assigned computing node, and
a position of the third one of the node positions is between the first and second node positions in the node position order.

15. The method of claim 11, comprising
establishing a first smooth growth non-overlapping ring network having a first node position order; and
establishing a second smooth growth non-overlapping ring network having a second, different node position order.

16. The method of claim 1, wherein the node position orders define direct communicative connections between the node positions that are immediately adjacent each other in the node position order.

17. The method of claim 11, comprising
providing a plurality of nodes;
providing a plurality of connectors having respective input and output ports;
assigning an identifier to the nodes, respectively, wherein the identifiers correspond to node positions of the established smooth growth non-overlapping ring network;
assigning the node positions of the established smooth growth non-overlapping ring network, respectively, to the connectors;
communicatively connecting the nodes with the respective connectors assigned to a node position corresponding to the node identifier;
situating the connectors relative to each other in a manner corresponding to the order of node positions such that at least one of the ports of a first one of the connectors assigned to a first one of the node positions is immediately adjacent at least one of the ports of a second one of the connectors assigned to a second one of the node positions that is immediately adjacent the first one of the node positions in the node position order.

18. The method of claim 17, comprising
providing a plurality of conductors;
communicatively connecting the conductors with at least selected ones of the ports;
situating some of the conductors between an input port of one of the nodes and an output port of another one of the nodes that is directly communicatively coupled with the one node; and
situating at least one other of the conductors between an input port and an output port of a selected one of the connectors at a node position that does not have a corresponding node.

19. The method of claim 18, comprising
subsequently removing the at least one other of the conductors;
communicatively connecting an added node with the selected connector;
situating one of the conductors between the input port of the added node and the output port of a first one of the nodes immediately adjacent the added node in the node position order; and
situating another one of the conductors between the output port of the added node and the input port of a second one of the nodes immediately adjacent the added node in the node position order.
